(19) United States
(12) Patent Application Publication
(10) Pub. No.: US 2022/0005077 A1
(43) Pub. Date: Jan. 6, 2022

(54) METHODS, SYSTEMS, AND DEVICES FOR SELF-CERTIFICATION OF BIAS ABSENCE

(71) Applicant: AT&T Intellectual Property I, L.P., Atlanta, GA (US)

(72) Inventors: Balachander Krishnamurthy, New York, NY (US); Subhabrata Majumdar, Jersey City, NJ (US); Ritwik Mitra, Trenton, NJ (US); David Poole, Maplewood, NJ (US)

(73) Assignee: AT&T Intellectual Property I, L.P., Atlanta, GA (US)

(21) Appl. No.: 16/919,457

(22) Filed: Jul. 2, 2020

(51) Int. Cl. G06Q 30/02; H04W 8/18; H04W 16/24; H04W 88/14; G06N 20/00

(52) U.S. Cl. CPC G06Q 30/0267; H04W 8/186; G06N 20/00; H04W 88/14; H04W 16/24

(57) ABSTRACT

Aspects of the subject disclosure may include, for example, embodiments receiving a notification of actions, determining a potential bias metric for the actions in response to analyzing the actions using a machine learning application, determining the potential bias metric for the actions is above a potential bias threshold for the actions, and adjusting the actions to mitigate potential bias in the actions according to the potential bias metric being above the potential bias threshold using the machine learning application. Further embodiments can include determining a potential bias metric for the adjusted actions in response to analyzing the adjusted actions using the machine learning application, determining the potential bias metric for the adjusted actions is below the potential bias threshold for the actions, and providing a notification that indicates to implement the adjusted actions. Other embodiments are disclosed.

### FIELD OF THE DISCLOSURE

The subject disclosure relates to methods, systems, and devices for self-certification of bias absence.

### BACKGROUND

Machine learning (ML) has become an integral part of many business processes in a variety of industries and prominent companies. In some applications, ML-based decision making can suffer from unintentional bias. Such bias may arise from selection and sampling of datasets, learning methods and models used, and other parts of the ML lifecycle. The unintentional bias can raise at least ethical or public relations concerns. Failure to detect, prevent, and mitigate unintentional bias in a timely manner can lead to damage to company brand image as well as significant economic costs.

Bias and fairness of ML-based decision making has attracted attention in academia and industry. However, current practices are believed to focus on addressing bias problems reactively. That is, detecting and mitigating bias is done once evidence of bias or unfairness is found in a ML model or in the resulting data from the ML model. Such current practices of detecting and mitigating bias only address bias reactively on a case-by-case basis i.e., only when it is deemed bias may be an issue. Further, current practices do not prevent bias from occurring in the ML model or in the data gathered/collected from the ML model proactively, and instead attempt to mitigate the bias post facto, after it is found to have occurred.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIGS. 2A-2B are block diagrams illustrating example, non-limiting embodiments of systems functioning within the communication network of FIG. 1 in accordance with various aspects described herein.

FIG. 2C depicts an illustrative embodiment of a method in accordance with various aspects described herein.

FIG. 2D is a block diagram illustrating an example, non-limiting embodiment of a system functioning within the communication network of FIG. 1 in accordance with various aspects described herein.

FIGS. 2E-2G depicts illustrative embodiments of methods in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for receiving a notification of a first group of actions to be implemented by a server, determining a potential bias metric for the first group of actions in response to analyzing the first group of actions using a machine learning application, determining the potential bias metric for the first group of actions is above a potential bias threshold for the first group of actions, and adjusting the first group of actions to mitigate potential bias in the first group of actions according to the potential bias metric being above the potential bias threshold using the machine learning application resulting in an adjusted first group of actions. Further embodiments can include determining a potential bias metric for the adjusted first group of actions in response to analyzing the adjusted first group of actions using the machine learning application, determining the potential bias metric for the adjusted first group of actions is below the potential bias threshold for the first group of actions, and providing a notification to the server that indicates to the server to utilize the adjusted first group of actions. Other embodiments are described in the subject disclosure.

One or more aspects of the subject disclosure include a potential bias metric for an ML problem. A potential bias metric quantifies the amount of bias present in the data or ML model outcomes, and should always be decided based upon the objective of the problem and impact of bias if any. In one embodiment, a potential bias metric can be a statistical test comparing two population proportions. In another embodiment, a potential bias metric can be disparate impact, defined as the ratio of occurrence probabilities of a binary quantity in two distinct populations. One definitive way to devise a potential bias metric is to consider the overall performance metric for the ML problem and apply the metric by groups of the sensitive category. As an example, if true positive rate (TPR) is a metric of overall model performance. One could calculate TPR within each group of a sensitive demographic category and consider their absolute difference as a potential bias metric in order to identify disparity in predictions among sensitive categories. Similar arguments could be made for false positive rate (FPR), false discovery rate (FDR) etc. among others. One could also consider a combination of such model performance metrics while evaluating the absence of bias. Model performance metrics are central to the overall design of the machine learning problem and can inform the design of potential bias metrics as well. Note however that, the choice of TPR, FPR and FDR etc. each have unique connotations for the type of bias one is interested in. Parity in TPR signifies that one wants to be “fair” in assigning positive decisions e.g., who is chosen to target for an ad in addressable advertising, while parity in FPR signifies that one wants to be equitable in the non-decisions e.g., who is decided not to be a target for an ad.

One or more aspects of the subject disclosure include a device, comprising a processing system including a processor, and a memory that stores executable instructions that, when executed by the processing system, facilitate performance of operations. The operations can comprise receiving a notification of a first group of actions to be implemented by a server. Further, the operations can comprise determining a potential bias metric for the first group of actions in response to analyzing the first group of actions using a machine learning application, determining the potential bias metric for the first group of actions is above a potential bias threshold for the first group of actions, and adjusting the first group of actions to mitigate potential bias in the first group of actions according to the potential bias metric being above the potential bias threshold using the machine learning application resulting in an adjusted first group of actions. Additional operations can comprise determining a potential bias metric for the adjusted first group of actions in response to analyzing the adjusted first group of actions using the machine learning application, determining the potential bias metric for the adjusted first group of actions is below the potential bias threshold for the first group of actions, and providing a notification to the server that indicates to the server to utilize the adjusted first group of actions.

One or more aspects of the subject disclosure include a machine-readable medium, comprising executable instructions that, when executed by a processing system including a processor, facilitate performance of operations. The operations can comprise adjusting a first group of actions to mitigate potential bias in the first group of actions according to a potential bias metric being above a potential bias threshold for the first group of action using a machine learning application resulting in an adjusted first group of actions, determining a potential bias metric for the adjusted first group of actions in response to analyzing the adjusted first group of actions using the machine learning application, and determining the potential bias metric for the adjusted first group of actions is below the potential bias threshold for the first group of actions. Further, the operations can comprise recording a self-certification register associated with the adjusted first group of actions, receiving a notification of a second group of actions to be implemented by a server, determining a potential bias metric for the second group of actions in response to analyzing the second group of actions using the machine learning application, and determining the potential bias metric for the second group of actions is above a potential bias threshold for the second group of actions. In addition, the operations can comprise determining the second group of actions is associated with the first group of actions, accessing the self-certification register associated with the adjusted first group of actions, and identifying an adjustment associated with the adjusted first group of actions from the self-certification register. Also, the operations can comprise adjusting the second group of actions to mitigate potential bias in the second group of actions according to the adjustment associated with the adjusted first group of actions using the machine learning application resulting in an adjusted second group of actions, determining a potential bias metric for the adjusted second group of actions in response to analyzing the adjusted second group of actions using the machine learning application, determining the potential bias metric for the adjusted second group of actions is below the potential bias threshold for the second group of actions, and providing a notification to the server that indicates to the server to implement the adjusted second group of actions.

One or more aspects of the subject disclosure include a method. The method can include determining, by a processing system including a processor, a potential bias metric for a first group of actions is above a potential bias threshold for the first group of actions in response to analyzing, by the processing system, the first group of actions using a machine learning application, and adjusting, by the processing system, the first group of actions to mitigate potential bias in the first group of actions according to the potential bias metric being above the potential bias threshold using the machine learning application resulting in an adjusted first group of actions. Further, the method can include determining, by the processing system, the potential bias metric for the adjusted first group of actions is below the potential bias threshold for the first group of actions in response to analyzing, by the processing system, the adjusted first group of actions using the machine learning application, and providing, by the processing system, a notification to a server that indicates to the server to implement the adjusted first group of actions.

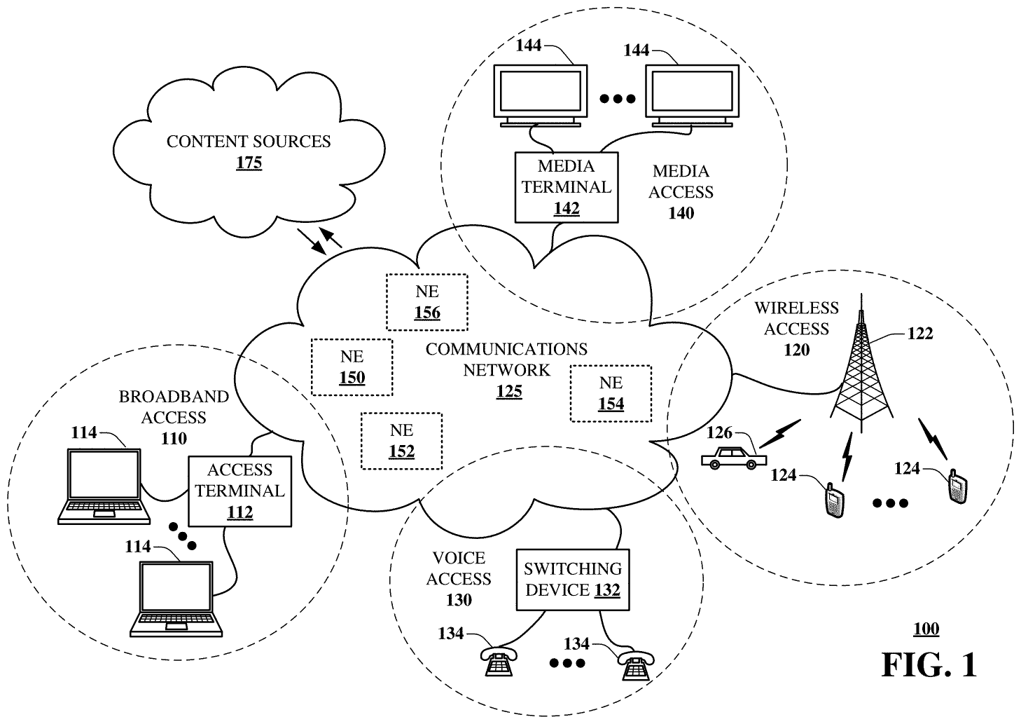

Referring now to FIG. 1, a block diagram is shown illustrating an example, non-limiting embodiment of a communications network 100 in accordance with various aspects described herein. For example, communications network 100 can facilitate in determining potential bias in a group of actions, adjusting the group of actions to mitigate the potential bias, and recording the adjustment in a self-certification register for future use. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

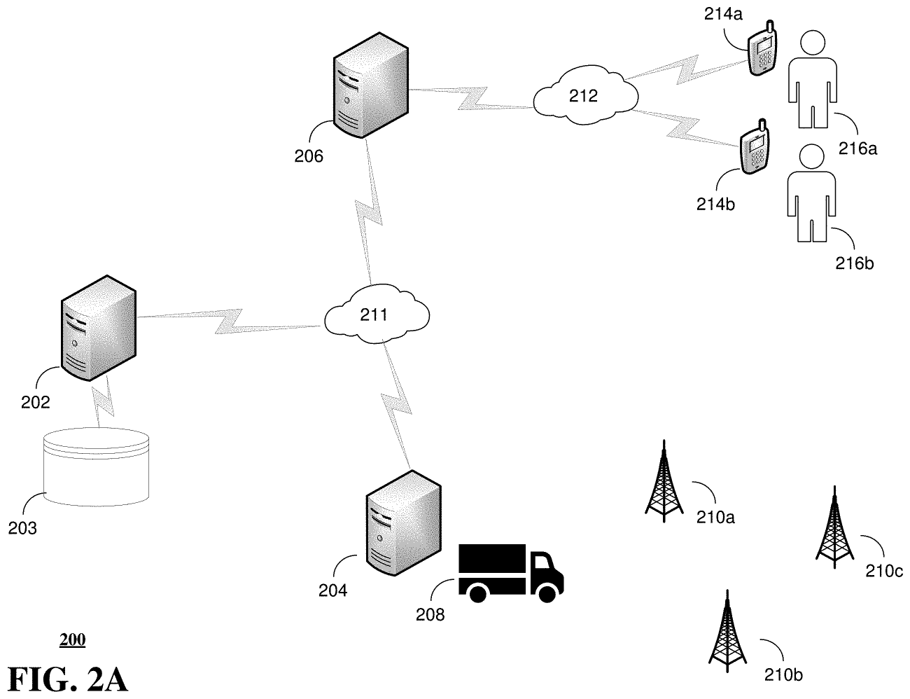

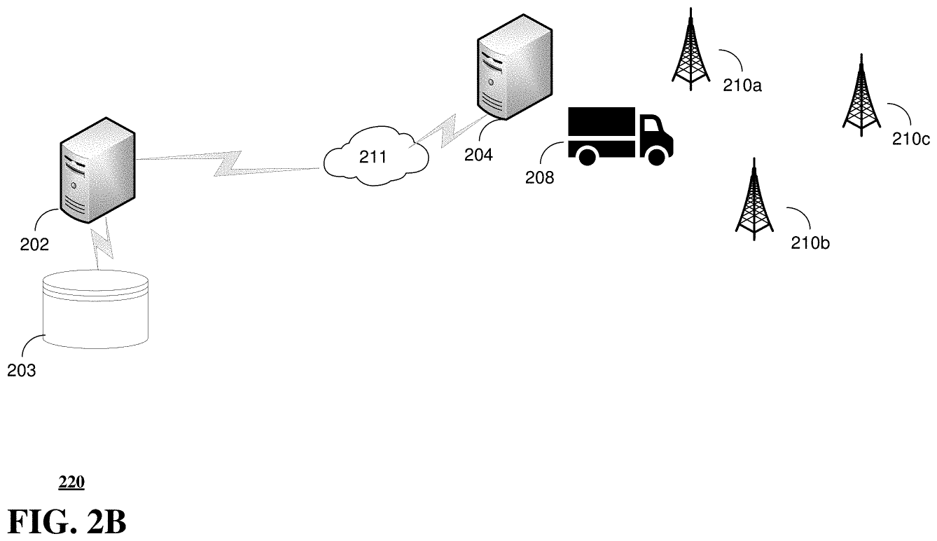

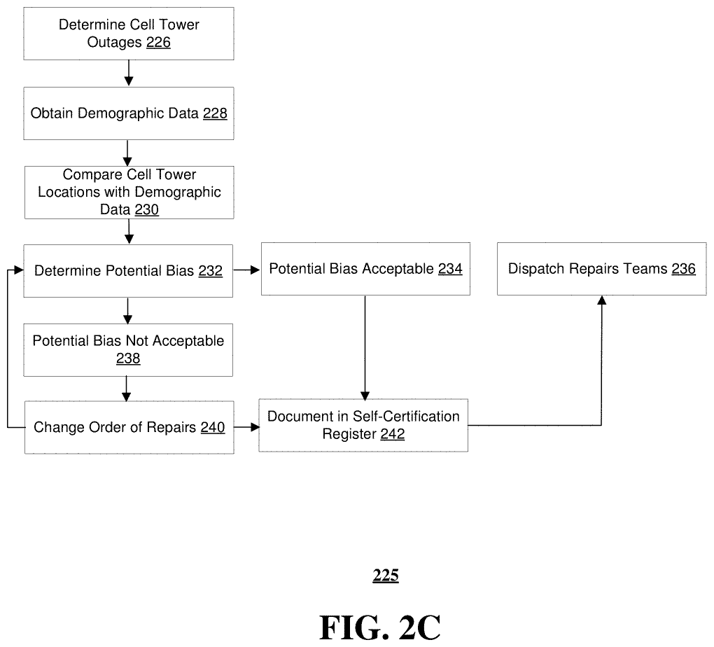

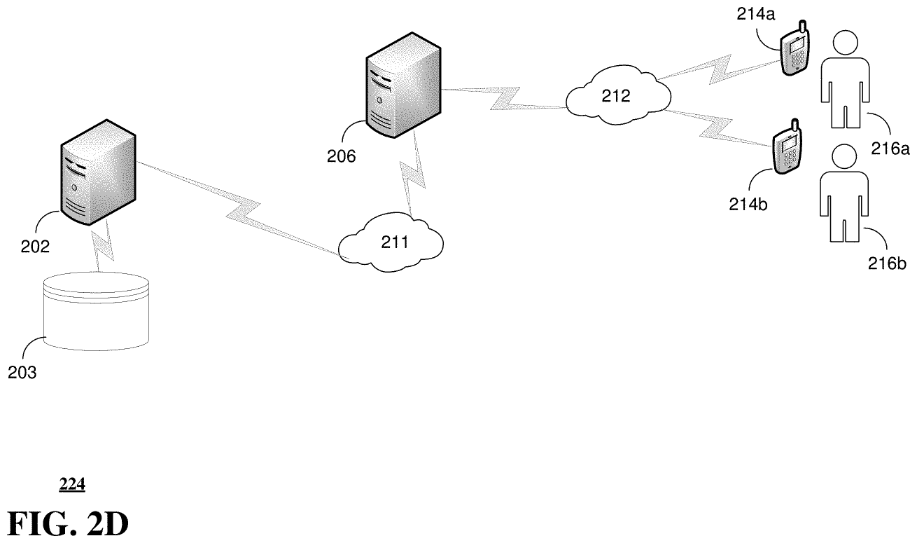

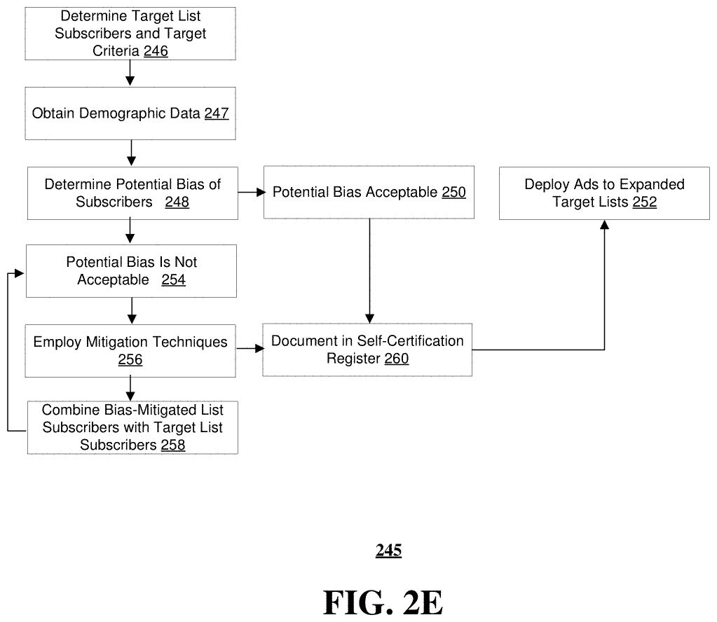

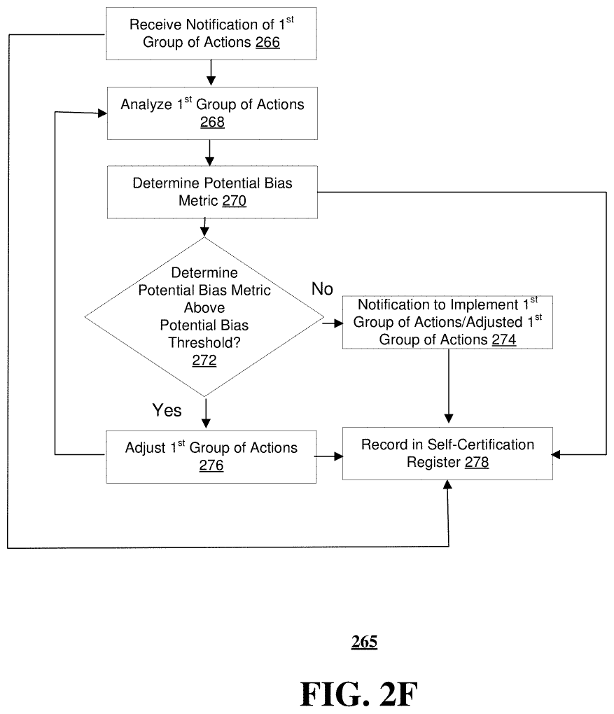

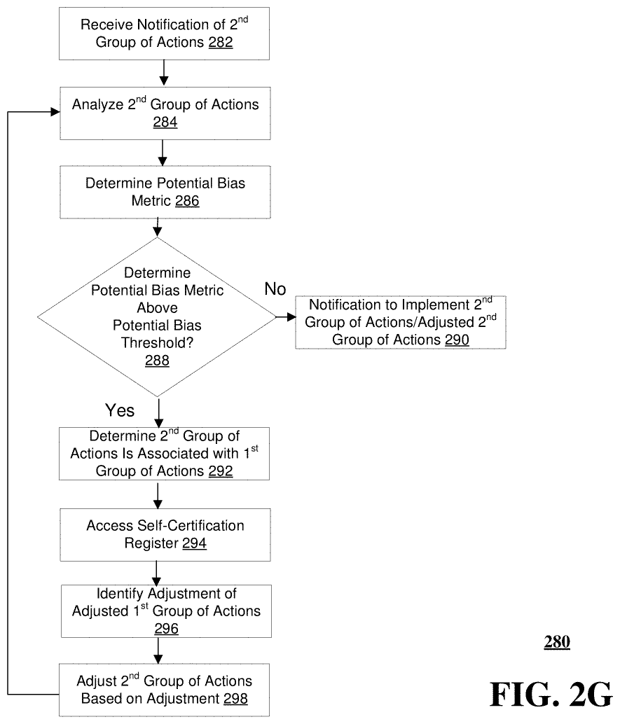

FIG. 2A is a block diagram illustrating an example, non-limiting embodiment of a system functioning within the communication network of FIG. 1 in accordance with various aspects described herein.

One or more embodiments describe a novel process to prevent potential bias and fairness issues affecting ML projects in a pro-active manner. Further, embodiments can incorporate a series of defensive checks for potential bias at each stage of an ML-based project lifecycle: data collection, processing, splitting data to train and test, model building, and validation. The checks are tailored to the intended outcomes of the specific use cases in a mechanized fashion. These checks provide a set of sufficient conditions, allowing a project to self-certify that potential bias is not going to be a problem at a certain stage given that conditions for that stage are satisfied. Such conditions may relate to the data collection (e.g., sampling strategy, supplementary data sources, privacy requirements), ML modeling and validation (e.g., features, techniques, evaluation metrics, validation samples), and end goal of the project (e.g., outcome of interest, target population base for deployment). Given a number of candidate sets of such conditions, embodiments can score each of them on how likely an ML project using that set of conditions would have the risk of potential bias within acceptable limits, select an appropriate set of conditions among them, and keep track of the outcomes for future reference. In some embodiments, the same data and same model could be used for a different outcome and deployed elsewhere for a different target population.

Embodiments enable ML projects to proactively prevent potential bias issues in the design phase rather than requiring a fix of potential bias problems post-hoc. Since potential bias prevention is configured into the build process itself and done before deployment, the positive affirmations generated by the process stages makes the end result more likely to be bias-free. This is cost-efficient, as only some projects (e.g., those projects with acceptability potential bias metric scores below a certain threshold) would need checks for potential bias detection and mitigation. Additionally, the type of potential bias checks that need to be done are highly tailored and relevant to the specific goals of the project. This avoids costly potential checks against a broader set of potential bias concerns that are likely to be irrelevant given the use cases planned. Since embodiments do not preclude follow up potential bias checks, any existing potential bias correction methods can still be applied at different stages of a standard ML model building process.

Referring to FIG. 2A, in one or more embodiments, a potential bias mitigation server 202 is communicatively coupled to server 204, and to server 206 over a communication network 211. Further, the communication network 211 can be a wireless communication network, a wired communication network, or a combination thereof. In addition, server 204 can be a server that schedules maintenance personnel who use a maintenance truck or vehicle 208 to repair cell phone tower outages at various cell phone towers 210a, 210b, 210c. Also, the server 206 can be an advertisement server that determines or identifies a group of subscribers of a platform (e.g., social media, streaming service, media content provider, etc.) to which to target advertisements. Further, the server 206 can provide the target advertisements over a communication network 212 to communication devices 214a, 214b associated with the subscribers 216a, 216b. The communication network 212 can be a wireless communication network, a wired communication network, or a combination thereof. In some embodiments, one or more of the functions performed by the potential bias mitigation server 202 can be combined with server 204 and/or server 206.

In one or more embodiments, the potential bias mitigation server 202 can receive a notification of a group of actions to be performed by either server 204, or server 206 that may incur potential bias. In one embodiment, the group of actions can include scheduling repairs to a group of cell tower outages 210a, 210b, 210c by server 204. In additional embodiments, the group of actions can include a scheduling of updating communication network infrastructure with new equipment in several different geographical areas. In another embodiment, the group of actions can include providing target advertisements to communication devices 214a, 214b associated with a group of subscribers 216a, 216b.

In further embodiments, the potential bias mitigation server 202 can determine a potential bias metric for the group of actions in response to analyzing the group of actions using one or more machine learning application(s). In addition, the potential bias mitigation server 202 can determine whether the potential bias metric is above or below a potential bias threshold for the group of actions. If the potential bias metric is below the potential bias threshold, then the potential bias for the group of actions is within an acceptable margin and the potential bias mitigation server 202 can provide a notification to server 204, or server 206 to continue to implement the group of actions without any adjustment. However, if the potential bias metric is above the potential bias threshold for the group of actions, then the group of actions may have potential bias that is not within an acceptable margin. Consequently, the potential bias mitigation server 202 can adjust the group of actions to mitigate potential bias in them according to the potential bias metric using the machine learning application resulting in an adjusted group of actions. Adjustment of the group of actions to mitigate potential bias can include scheduling repairs of cell tower outages in a different order, scheduling more personnel to complete cell tower outages more quickly, removing a portion of a group of subscribers for a target advertisement, adding another group of subscribers to provide the target advertisement, etc. Further details of examples of adjusting the group of actions are discussed with respect to FIGS. 2B-2E.

In one or more embodiments, as part of validating each stage of the potential bias mitigation process, the potential bias mitigation server 202 can determine a potential bias metric for the adjusted group of actions in response to analyzing the adjusted group of actions using the machine learning application. Further, the potential bias mitigation server 202 can determine whether the potential bias metric is above or below the potential bias threshold for the group of actions. If the potential bias metric is above the potential bias threshold, then the potential bias is not within an acceptable margin and further adjustment of the group of actions can be made by the potential bias mitigation server 202. If the potential bias metric is below the potential bias threshold, then the potential bias is within an acceptable margin and the potential bias mitigation server 202 can provide a notification to server 204, or server 206 that indicates to implement the adjusted group of action instead of the original group of actions.

In one or more embodiments, the potential bias mitigation server 202 can record aspects of the potential bias mitigation process on the group of actions into a self-certification register 203 that can be used by the potential bias mitigation server 202 to mitigate potential bias in another group of actions in the future that may be similar to the group of actions associated with the self-certification register 203. In some embodiments, the self-certification register can be a database communicatively coupled to the potential bias mitigation server 202 over a communication network (e.g., wireless communication network, wired communication network, or combination thereof). In other embodiments, the self-certification register can be stored in the memory of the potential bias mitigation server 202 itself. Examples of aspects of the potential bias mitigation process that may be recorded into the self-certification register by the potential bias mitigation server 202 can include the potential bias metric for the group of actions, the potential bias metric for the adjusted group of actions, the potential bias threshold for the group of actions, the group of actions themselves, the adjustment of the group of actions to mitigate the potential bias, the adjusted group of actions, and any combination thereof.

In one or more embodiments, the potential bias mitigation server 202 can receive a notification of another group of actions to be implemented by another server 204, or server 206. Further, the potential bias mitigation server 202 can determine that this other group of actions is associated with the previous group of actions. For example, the previous group of actions may be a schedule of repairs of cell phone tower outages over a geographic area for one time period and this other group of actions is also a schedule of repairs of cell phone tower outages in the same geographic area for another time period. In another example, the previous group of actions may be providing a target advertisement (e.g., mortgage advertisement) to a group of subscribers and this other group of actions can be providing a target advertisement of the same type (e.g., mortgage advertisement) to the same group of subscribers. Further, the potential bias mitigation server 202 can determine a potential bias metric for the other group of actions in response to analyzing the other group of actions using the machine learning application. In addition, the potential bias mitigation server 202 can determine whether the potential bias metric is above or below the potential bias threshold for the other group of actions (which can be likely the same as the potential bias threshold for the previous group of actions). If the potential bias metric is below the potential bias threshold, then the potential bias for the other group of actions is within an acceptable margin and the potential bias mitigation server 202 can notify server 204, or server 206 to continue to implement the other group of actions. If the potential bias is above the potential bias threshold, then the potential bias for the other group of actions is not within an acceptable margin. Further, the potential bias mitigation server 202 can access the self-certification register 203 associated with previous group of actions and can identify an adjustment associated with the previous group of actions from the self-certification register. In addition, the potential bias mitigation server 202 can adjust the other group of actions to mitigate the potential bias according to the adjustment associated with the previous group of actions using the machine learning application. Also, in accordance with validating each stage of the potential bias mitigation process, the potential bias mitigation server 202 can determine the potential bias metric for the adjusted other group of actions in response to analyzing the adjusted other group of actions using the machine learning application. If the potential bias metric for the adjusted other group of actions is above the potential bias metric threshold, then the potential bias is still not within an acceptable margin and the potential bias mitigation server 202 may further adjust the other group of actions to mitigate the potential bias using the machine learning application. If, however, the potential bias metric for the adjusted other group of actions is below the potential bias metric threshold, then the potential bias for the adjusted other group of actions is within an acceptable margin and the potential bias mitigation server 202 can send server 204, or server 206 a notification that indicates to server 204, or server 206 to implement the adjusted other group of actions.

Referring to FIG. 2B and FIG. 2C, one or more embodiments are directed to a system 220 for cell tower repair prioritization. In all examples the preemptive prevention of potential bias would ensure product integrity, preservation of customer loyalty, and protection of brand image. When technical faults are reported in a mobility network, automated operations management ML algorithms are used to prioritize the dispatch of repair personnel and resources to the cell tower locations 210a, 210b, 210c. Unconscious potential bias in this situation can involve demographic prioritization of neighborhoods, where a seemingly objective set of locations output by the ML algorithms could produce unintentional potential bias outcomes.

In one or more embodiments, steps for proactively mitigating potential bias for prioritization of cell tower repairs can be as follows. The potential bias mitigation server 202 can obtain and determine cell tower outages, at 226. Before generation of any cell tower alerts, the potential bias mitigation server 202 can extract/obtain, at 228, any relevant demographic data from the US census or other reliable source, preferably at the zip code level. As the ML algorithm generates repair alerts for cell tower locations 210a, 210b, 210c over a fixed time period (e.g., a day), the potential bias mitigation server 202 can immediately compare the tower locations to the demographics of the zip codes, at 230, in which they are located. Further, the potential bias mitigation server 202 can, at 232, determine potential bias. If potential bias is present in the order of dispatching repair teams and the potential bias mitigation server 202, at 238, determines that the potential bias is not acceptable, then, the potential bias mitigation server 202 can permute or change, at 240, the order of the repairs until the potential bias is eliminated. If necessary, further alerts can be generated prior to permutation. The permutation of the order of dispatching repair teams can or should be as minimal as possible while still eliminating the potential bias, and it can be thought of as a final additional step in the output of the ML algorithm. In this way the algorithm is proactively self-certifying in the manner described earlier, prior to the dispatch of any repair teams to cell tower locations 210a, 210b, 210c, and it avoids legal or ethical concerns resulting from unintended bias in the order of dispatching repair teams. It is important to document and keep track of any demographic bias detected. At each step of this procedure, therefore, the potential bias mitigation server 202 can, at 242, document whether or not any bias was detected, and if so, what the results of the ML algorithm would be if the bias was corrected and what they would be if the bias was allowed to remain unchecked. In other words, in this example potential bias mitigation server 202 can record the order of cell towers 210a, 210b, 210c recommended for repair. This documentation of the self-certification process allows for post hoc analysis if need be, and the documentation itself can be referred to as a self-certification register. Further, once the potential bias is determined to be acceptable by the potential bias mitigation server at 234, and the potential bias mitigation server documents as such in the self-certification register at 242, then the potential mitigation server can dispatch, at 236, repair teams in the order indicated by the algorithm.

Referring to FIG. 2D and FIG. 2E, in one or more embodiments, the system 224 determines a group of subscribers for targeting of an advertisement. In targeted advertising, an advertiser comes to an ad platform (e.g. a retail website, a social media platform, or a TV broadcast service provider) with a targeting criteria and/or a list of subscriber identifiers (e.g., identified by advertiser's internal ID system), which they want targeted for placement of specific ads. The ad platform finds a subset of their subscriber base that matches those criteria and schedules delivery of specific ads to those subscribers. In this context, an ad platform might offer look-alike modeling (i.e., look-alike modeling is a methodology advertisers can use to define consumers most likely to engage with their marketing messages by considering common traits or behaviors among current customers and seeking consumers who share those same characteristics) to the advertiser which works as follows. The platform would model the targeted subscribers based on their behavior on the platform and find other subscribers, whose engagement with the platform promises similar levels of pay-off if they were to be shown the ads as well. This expanded list of subscribers would then be offered to the advertiser as a service. Targeted advertising is inherently selective and as such, is potentially biased against certain groups while favoring/targeting others. This potential bias is not inherently discriminatory for most advertisement categories. However, for some advertisement categories such as mortgage, bank loan, recruitment, etc., selective targeting (or excluding) of certain demographic categories can be considered potentially biased and would leave the advertisers and potentially the platform with adverse consequences. Building a look-alike model based on a potentially biased targeting criteria might lead to a potentially biased expanded set of targeted subscribers. The following can be viewed through the lens of the ad platform that is planning to build the look-alike model and discuss the possible self-certification steps. As part of this process, the self-certification register is discussed, where at each step, the type of bias (if any) present in the data at that step is curated, what the model results of the corresponding step would look like without addressing this potential bias, and the results as they are after addressing the potential bias. This self-certification register is designed to keep track of the potential bias detection/mitigation employed at each step and potential impact thereof. At the end of the project, this self-certification register would work as concrete documentation of the self-certification. Other techniques for targeted advertising can also utilize one or more of the exemplary embodiments described herein, including ad auctions, (e.g., real-time or near-real-time) at various device that are providing various communication services, such as Over-The-Top video services.

Details of the self-certification process follows. After the advertiser provides a target-list or targeting criteria, the ad-platform matches them to the subscribers of the platform and collates data on their behavior on the platform. The potential bias mitigation server 202 can, at 246, obtain and/or determine the target list subscribers and target criteria. Given the ad category's potential for bias, additional demographic data for the matched set of subscribers is also collected, at 247, by the potential bias mitigation server 202. For the matched set of subscribers, potential disparate impact of the targeting on sensitive demographic features is studied through one or more potential bias metrics, at 248. If the amount of potential bias (measured through a metric) falls within an allowable margin of error, at 250, as determined by the potential bias mitigation server 202, analysis proceeds to the next step. Otherwise, at 254, the potential bias mitigation server 202 determines that the potential bias of the demographic features of the set of subscribers is not acceptable. Thus, one or more of the potential bias mitigation techniques (e.g., disparate impact remover, reweighing, etc.) are employed by the potential bias mitigation server 202, at 256, to create a more uniform representation. As a certification that the potential bias has been addressed, in the aforementioned register, potential impact of the potential bias is noted by the potential bias mitigation server 202, at 260, in terms of e.g., the disparate impact before and after the mitigation is performed. Once the potential bias is addressed the process moves to the next stage of the analysis. The bias-mitigated list of subscribers is now combined by the potential bias mitigation server 202, at 258, with the rest of the subscribers not in the target list along with their behavioral data. This complete set is now used for building the look-alike model using one of the several possible approaches such as classification or clustering.

Once the model predicts an additional list of subscribers as possible targets for the ad, comparison of the proportions of people in different categories of the sensitive demographic feature is performed again through one or more of the potential bias metrics. If the results show differential proportions, the look-alike model is re-fitted with additional constraints ensuring equality of proportions. Algorithms such as adversarial debiasing or more general meta-algorithms for fair classifications can be used for this purpose. Examples of additional algorithms can include optimized pre-processing, disparate impact remover, reject option classification, and equalized odds algorithms. Potential bias metrics are calculated again for the results in the fairness-constrained refitted model. The results of both bias-unaware and bias aware models are noted by the potential bias mitigation server 202, at 260, in the self-certification register in terms of their prediction accuracy, as well as bias in the outcome in terms of the potential bias metric. If the bias-aware model results show absence of bias, or that the potential bias is acceptable, at 250, it is documented in the self-certification register, at 260, and the expanded target list is used for deploying/placing ads, at 252. On the other hand, owing to infeasibility of the constraints, the re-fitted model might fail to remove the potential bias. This would be noted in the self-certification register as well, at 260, by the potential bias mitigation server 202. In such cases, the platform might either use further re-weighing or manually add subscribers from the underrepresented category of the sensitive demographic to the expanded list in order to attain uniformity. Such re-weighting and its impact on the prediction accuracy as well as bias is noted in the self-certification register. After which, the ads are deployed to the expanded list of targets. The above steps suggest a way of providing self-certification in creating look-alike models for advertising, by addressing potentials for bias at every stage of the analysis (and taking mitigation steps if necessary)—from data collection to modeling to deployment. Additionally, the self-certification register keeps track of the certification of removal of potential bias at each stage and the consequent impact on the model.

Referring to FIG. 2F, in one or more embodiments, a method 265, can be performed by the potential bias mitigation server in FIG. 2A or by another server in FIG. 2A that incorporates the functions of the potential bias mitigation server as described herein. The method 265 can include a server, at 266, receiving a notification of a first group of actions to be implemented by another server (or to be implemented by itself). Further, the method 265 can include the server, at 268, analyzing the first group of actions using a machine learning application. In addition, the method 265 can include the server, at 270, determining a potential bias metric for the first group of actions. In some embodiments, the server can include determining a potential bias metric for the first group of actions in response to analyzing the first group of actions using a machine learning application.

In one or more embodiments, the method 265 can include the server, at 272, determining whether the potential bias metric for the first group of actions is above or below a potential bias threshold for the first group of actions. If the potential bias metric for the first group of actions is below the threshold, then the method 265 can include the server, at 274, providing a notification to the server that indicates to the server to implement the first group of actions because the potential bias is within an acceptable margin of error. However, if the server determines the potential bias metric for the first group of actions is above a potential bias threshold for the first group of actions, then the method 265 can include the server, at 276, adjusting the first group of actions to mitigate potential bias in the first group of actions according to the potential bias metric being above the potential bias threshold using the machine learning application resulting in an adjusted first group of actions. Further, the method 265 can include the server, at 268, analyzing the adjusted first group of actions using the machine learning application. In addition, the method 265 can include the server, at 270, determining a potential bias metric for the adjusted first group of actions. In some embodiments, the server can include determining a potential bias metric for the adjusted first group of actions in response to analyzing the adjusted first group of actions using the machine learning application. Also, the method 265 can include the server, at 272, determining whether the potential bias metric for the adjusted first group of actions is above or below the potential bias threshold for the first group of actions. If the potential bias metric for the adjusted first group of actions is below the potential bias threshold for the first group of actions, then the method 265 can include the server, at 274, providing a notification to the server that indicates to the server to utilize the adjusted first group of actions. In addition, the method 265 can include the server, at 278, recording a self-certification register associated with the adjusted first group of actions. The recording of the self-certification register can comprises recording, into the self-certification register the potential bias metric for the first group of actions, the potential bias metric for the adjusted first group of actions, the potential bias threshold for the first group of actions, the first group of actions, the adjusting of the first group of actions to mitigate the potential bias, the adjusted first group of actions, and a combination thereof.

In one or more embodiments, the first group of actions include scheduling repairs to a group of cell tower outages. In some embodiments, the analyzing of the first group of actions comprises obtaining demographic information for a group of locations associated with the group of cell tower outages and analyzing the demographic information for the group of locations using the machine learning application. In other embodiments, the adjusting of the first group of actions comprises adjusting a schedule of the repairs of the group of cell tower outages according to the demographic information for the group of locations using the machine learning application.

In one or more embodiments, the first group of actions include providing a target advertisement to a group of subscribers. In some embodiments, the analyzing of the first group of actions comprises obtaining demographic information for the group of subscribers and analyzing the demographic information for the group of subscribers using the machine learning application. In other embodiments, the adjusting of the first group of actions comprises adjusting the group of subscribers according to the demographic information for the group of subscribers using the machine learning application. In further embodiments, the adjusting of the group of subscribers comprises adding an additional group of subscribers. In additional embodiments, the analyzing of the adjusted group of subscribers comprises obtaining demographic information for the additional group of subscribers and analyzing the demographic information for the group of subscribers and the demographic information for the additional group of subscribers using the machine learning application.

Referring to FIG. 2G, in one or more embodiments, a method 280, can be performed by the potential bias mitigation server in FIG. 2A or by another server in FIG. 2A that incorporates the functions of the potential bias mitigation server as described herein. The method 280 in FIG. 2G can be implemented after the method 265 in FIG. 2F. The method 280 can include a server, at 282, receiving a notification of a second group of actions from another server (or to be implemented by the server itself). Further, the method 280 can include the server, at 284, analyzing the second group of actions using the machine learning application. In addition, the method 280 can include the server, at 286, determining a potential bias metric for the second group of actions. In some embodiment, the server can include determining a potential bias metric for the second group of actions in response to analyzing the second group of actions using the machine learning application. The method 280 can include the server, at 288, determining whether the potential bias metric for the second group of actions is above or below a potential bias threshold for the second group of actions. If the potential bias metric is below the potential bias threshold for the second group of actions, the method 280 can include the server, at 290, providing a notification to the server that indicates to the server to implement the second group of actions. However, if the potential bias metric is above the potential bias threshold for the second group of actions, the method 280 can include the server, at 292, determining the second group of actions is associated with the first group of actions. Further, the method 280 can include the server, at 294, accessing the self-certification register associated with the adjusted first group of actions. In addition, the method 280 can include the server, at 296, identifying an adjustment associated with the adjusted first group of actions from the self-certification register. Also, the method 280 can include the server, at 298, adjusting the second group of actions to mitigate potential bias in the second group of actions according to the adjustment associated with the adjusted first group of actions using the machine learning application resulting in an adjusted second group of actions.

In one or more embodiments, the method 280 can include the server, at 284, analyzing the adjusted second group of actions using the machine learning application. Further, the method 280 can include the server, at 286, determining a potential bias metric for the adjusted second group of actions. In some embodiments, the server can include determining a potential bias metric for the adjusted second group of actions in response to analyzing the adjusted second group of actions using the machine learning application. In addition, the method 280 can include the server, at 288, determining the potential bias metric for the adjusted second group of actions is below the potential bias threshold for the second group of actions. Also, the method 280 can include the server, at 290, providing a notification to the server that indicates to the server to implement the adjusted second group of actions.

While for purposes of simplicity of explanation, the respective processes are shown and described as a series of blocks in FIGS. 2C, 2E, 2F, and 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. Further, one block n the method can be in response to another block, for example. That is, in some embodiments, a first block listed prior to a second block can be such that the second block is implemented in response to the first block.

Portions of some embodiments can be combined with portions of other embodiments.

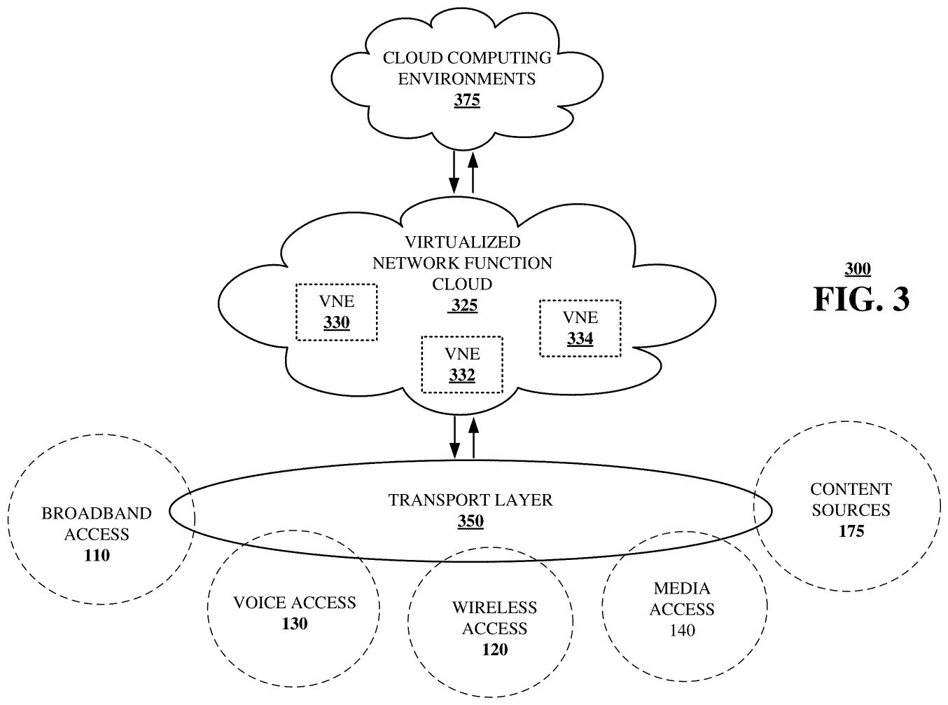

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of communication network 100, the subsystems and functions of systems and methods presented in FIGS. 1, 2A-2G, and 3. For example, virtualized communication network 300 can facilitate in whole or in part determining potential bias in a group of actions, adjusting the group of actions to mitigate the potential bias, and recording the adjustment in a self-certification register for future use.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

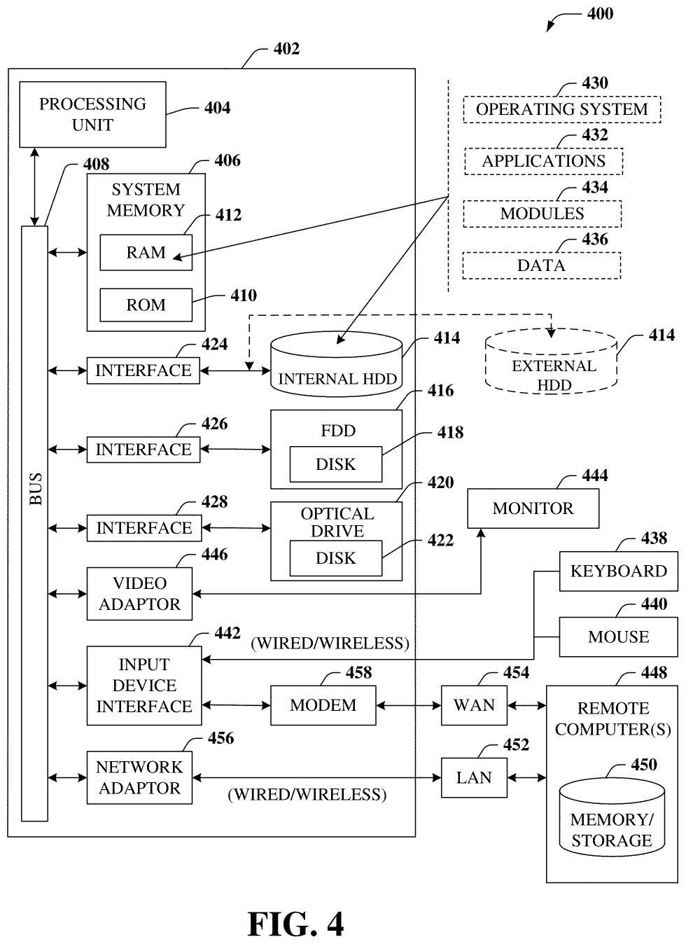

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part determining potential bias in a group of actions, adjusting the group of actions to mitigate the potential bias, and recording the adjustment in a self-certification register for future use. Further, the servers and communication devices described in FIGS. 2A-2G can each comprise computing environment 400.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

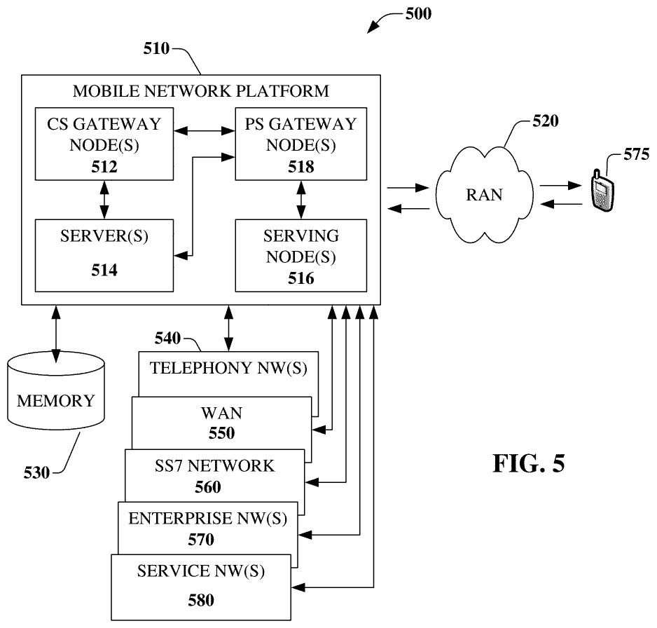

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part determining potential bias in a group of actions, adjusting the group of actions to mitigate the potential bias, and recording the adjustment in a self-certification register for future use. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

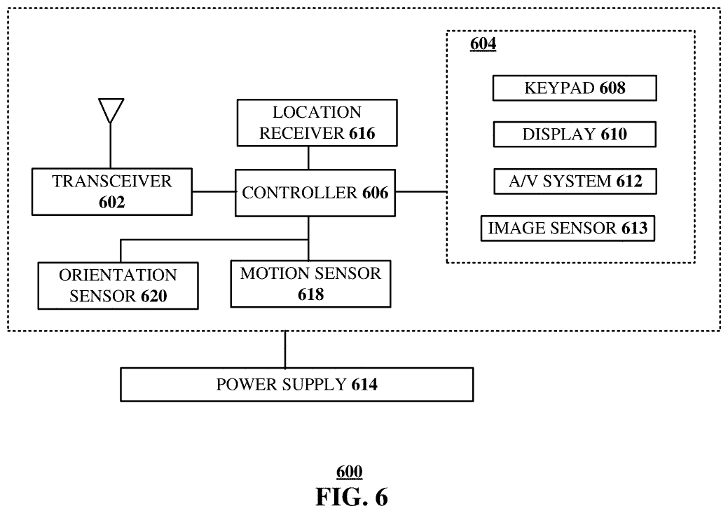

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part determining potential bias in a group of actions, adjusting the group of actions to mitigate the potential bias, and recording the adjustment in a self-certification register for future use. Further, the servers and communication devices described in FIGS. 2A-2G can each comprise communication device 600.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also use machine learning (ML) to facilitate automating one or more features described herein. The embodiments (e.g., in connection with automatically identifying acquired cell sites that provide a maximum value/benefit after addition to an existing communication network) can employ various ML-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through machine learning (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving a notification of a first group of actions to be implemented by a server;
determining a potential bias metric for the first group of actions in response to analyzing the first group of actions using a machine learning application;
determining the potential bias metric for the first group of actions is above a potential bias threshold for the first group of actions;
adjusting the first group of actions to mitigate potential bias in the first group of actions according to the potential bias metric being above the potential bias threshold using the machine learning application resulting in an adjusted first group of actions;
determining a potential bias metric for the adjusted first group of actions in response to analyzing the adjusted first group of actions using the machine learning application;
determining the potential bias metric for the adjusted first group of actions is below the potential bias threshold for the first group of actions; and
providing a notification to the server that indicates to the server to implement the adjusted first group of actions.

2. The device of claim 1, wherein the operations further comprise recording a self-certification register associated with the adjusted first group of actions.

3. The device of claim 2, wherein the recording of the self-certification register comprises recording, into the self-certification register, one of the potential bias metric for the first group of actions, the potential bias metric for the adjusted first group of actions, the potential bias threshold for the first group of actions, the first group of actions, the adjusting of the first group of actions to mitigate the potential bias, the adjusted first group of actions, and a combination thereof.

4. The device of claim 2, wherein the operations comprise:
receiving a notification of a second group of actions to be implemented by the server;
determining a potential bias metric for the second group of actions in response to analyzing the second group of actions using the machine learning application;
determining the potential bias metric for the second group of actions is above a potential bias threshold for the second group of actions;
determining the second group of actions is associated with the first group of actions;
accessing the self-certification register associated with the adjusted first group of actions;
identifying an adjustment associated with the adjusted first group of actions from the self-certification register;
adjusting the second group of actions to mitigate potential bias in the second group of actions according to the adjustment associated with the adjusted first group of actions using the machine learning application resulting in an adjusted second group of actions;
determining a potential bias metric for the adjusted second group of actions in response to analyzing the adjusted second group of actions using the machine learning application;
determining the potential bias metric for the adjusted second group of actions is below the potential bias threshold for the second group of actions; and
providing a notification to the server that indicates to the server to implement the adjusted second group of actions.

5. The device of claim 1, wherein the first group of actions include scheduling repairs to a group of cell tower outages.

6. The device of claim 5, wherein the analyzing of the first group of actions comprises:
obtaining demographic information for a group of locations associated with the group of cell tower outages; and
analyzing the demographic information for the group of locations using the machine learning application, wherein the adjusting of the first group of actions comprises adjusting a schedule of the repairs of the group of cell tower outages according to the demographic information for the group of locations using the machine learning application.

7. The device of claim 1, wherein the first group of actions include providing a target advertisement to a group of subscribers.

8. The device of claim 7, wherein the analyzing of the first group of actions comprises:
obtaining demographic information for the group of subscribers; and
analyzing the demographic information for the group of subscribers using the machine learning application, wherein the adjusting of the first group of actions comprises adjusting the group of subscribers according to the demographic information for the group of subscribers using the machine learning application.

9. The device of claim 8, wherein the adjusting of the group of subscribers comprises adding an additional group of subscribers to the group of subscribers.

10. The device of claim 9, wherein the analyzing of the adjusted first group of actions comprises:
obtaining demographic information for the additional group of subscribers; and
analyzing the demographic information for the group of subscribers and the demographic information for the additional group of subscribers using the machine learning application.

11. A machine-readable medium, comprising executable instructions that, when executed by a processing system including a processor, facilitate performance of operations, the operations comprising:
adjusting a first group of actions to mitigate potential bias in the first group of actions according to a potential bias metric being above a potential bias threshold for the first group of action using a machine learning application resulting in an adjusted first group of actions;
determining a potential bias metric for the adjusted first group of actions in response to analyzing the adjusted first group of actions using the machine learning application;
determining the potential bias metric for the adjusted first group of actions is below the potential bias threshold for the first group of actions;
recording a self-certification register associated with the adjusted first group of actions;
receiving a notification of a second group of actions to be implemented by a server;
determining a potential bias metric for the second group of actions in response to analyzing the second group of actions using the machine learning application;
determining the potential bias metric for the second group of actions is above a potential bias threshold for the second group of actions;
determining the second group of actions is associated with the first group of actions;
accessing the self-certification register associated with the adjusted first group of actions;
identifying an adjustment associated with the adjusted first group of actions from the self-certification register;
adjusting the second group of actions to mitigate potential bias in the second group of actions according to the adjustment associated with the adjusted first group of actions using the machine learning application resulting in an adjusted second group of actions;
determining a potential bias metric for the adjusted second group of actions in response to analyzing the adjusted second group of actions using the machine learning application;
determining the potential bias metric for the adjusted second group of actions is below the potential bias threshold for the second group of actions; and
providing a notification to the server that indicates to the server to implement the adjusted second group of actions.

12. The machine-readable medium of claim 11, wherein the recording of the self-certification register comprises recording, into the self-certification register, one of the potential bias metric for the first group of actions, the potential bias metric for the adjusted first group of actions, the potential bias threshold for the first group of actions, the first group of actions, the adjusting of the first group of actions to mitigate the potential bias, the adjusted first group of actions, and a combination thereof.

13. The machine-readable medium of claim 11, wherein the operations comprise:
prior to the adjusting of the first group of actions, receiving a notification of the first group of actions to be implemented by the server;
determining the potential bias metric for the first group of actions in response to analyzing the first group of actions using the machine learning application; and
determining the potential bias metric for the first group of actions is above the potential bias threshold for the first group of actions.

14. The machine-readable medium of claim 11, wherein the first group of actions include repairing a first group of cell tower outages and the second group of actions include repairing a second group of cell tower outages.

15. The machine-readable medium of claim 11, wherein the first group of actions include providing a target advertisement to a first group of subscribers and the second group of actions include providing another target advertisement to a second group of subscribers.

16. A method, comprising:
determining, by a processing system including a processor, a potential bias metric for a first group of actions is above a potential bias threshold for the first group of actions in response to analyzing, by the processing system, the first group of actions using a machine learning application;
adjusting, by the processing system, the first group of actions to mitigate potential bias in the first group of actions according to the potential bias metric being above the potential bias threshold for the first group of actions using the machine learning application resulting in an adjusted first group of actions;
determining, by the processing system, the potential bias metric for the adjusted first group of actions is below the potential bias threshold for the first group of actions in response to analyzing, by the processing system, the adjusted first group of actions using the machine learning application; and
providing, by the processing system, a notification to a server that indicates to the server to implement the adjusted first group of actions.

17. The method of claim 16, comprising recording, by the processing system, a self-certification register associated with the adjusted first group of actions, wherein the recording of the self-certification register comprises recording, by the processing system, into the self-certification register, one of the potential bias metric for the first group of actions, the potential bias metric for the adjusted first group of actions, the potential bias threshold for the first group of actions, the first group of actions, the adjusting of the first group of actions to mitigate the potential bias, the adjusted first group of actions, and a combination thereof.

18. The method of claim 17, comprising:
receiving, by the processing system, a notification of a second group of actions to be implemented by the server;
determining, by the processing system, a potential bias metric for the second group of actions is above a potential bias threshold for the second group of actions in response to analyzing, by the processing system, the second group of actions using the machine learning application;
determining, by the processing system, the second group of actions is associated with the first group of actions;
accessing, by the processing system, the self-certification register associated with the adjusted first group of actions;
identifying, by the processing system, an adjustment associated with the adjusted first group of actions from the self-certification register;
adjusting, by the processing system, the second group of actions to mitigate potential bias in the second group of actions according to the adjustment associated with the adjusted first group of actions using the machine learning application resulting in an adjusted second group of actions;
determining, by the processing system, the potential bias metric for the adjusted second group of actions is below the potential bias threshold for the second group of actions in response to analyzing, by the processing system, the adjusted second group of actions using the machine learning application; and
providing, by the processing system, a notification to the server that indicates to the server to implement the adjusted second group of actions.

19. The method of claim 16, wherein the first group of actions include repairing a group of cell tower outages.

20. The method of claim 16, wherein the first group of actions include providing a target advertisement to a group of subscribers.
